(19) United States
(12) Patent Application Publication
(10) Pub. No.: US 2004/0205661 A1
(43) Pub. Date: Oct. 14, 2004

(54) System and method of reviewing and revising business documents

(76) Inventor: James David Gallemore, St. Louis, MO (US)

Correspondence Address: THOMPSON COBURN, LLP, ONE US BANK PLAZA, SUITE 3500, ST LOUIS, MO, 63101, US

(21) Appl. No.: 10/154,901

(22) Filed: May 23, 2002

(51) Int. Cl. G06F 17/24

(52) U.S. Cl. 715/530; 707/6

(57) ABSTRACT

An improved system and method of creating and revising business and governmental documents. General and specialized dictionaries are used to compare words and groups of words (phrases, word associations, and the like) in the dictionaries with words and groups of words inputted by the user into the document. The words and groups of words in the dictionaries have associated therewith various usage levels, based upon the position of the user in the organization and the part of the organization from which the document originates. Different dictionaries may be used for different entities within the organization. Words and phrases deemed unsuitable for certain users or parts of the organization may be suitable if created by other users or other parts of the organization. A word or group of words deemed unsuitable results in a message being sent. The message may be sent to the user, in which instance it may contain an explanation of why the word or group of words is unsuitable and a suggested alternative wording. The message may also (or instead) be sent to a supervisor or other personnel with authority to review the communication, such as law department personnel. Reports identifying the unsuitable words, by user, are provided to supervisory personnel as desired.

### CROSS-REFERENCE TO RELATED APPLICATIONS

None.

### STATEMENT REGARDING FEDERALLY SPONSORED RESEARCH OF DEVELOPMENT.

Not Applicable.

### BACKGROUND OF THE INVENTION

This invention relates generally to document creation and revision in the business context, and more particularly to systems and methods for improving the suitability of language used in documents created for business purposes. For purposes of this specification, “business” is intended to include organizations and groups such as corporations, partnerships, governmental entities, non-profit organizations, and the like.

Millions of business people go to work each day and create documents. These documents cover a broad spectrum of business activities and range from highly formal planning, analysis, and reporting documents to the most popular, informal form of business communication, e-mail. The vast majority of these business people would never knowingly break the law or violate regulatory rules, and most of the time, the documents they create reflect, without ambiguity, their proper intentions. But, not always. The law and governmental regulation are becoming more and more complex. At the same time, written communication has become more pervasive and more casual in nature. The hasty selection of a few wrong words or phrases can make an innocent document appear otherwise, creating easy fodder for those who might accuse the business of wrongdoing. Such documents, when discovered in the course of litigation can result in fines, penalties, and legal rulings with potentially profound effects. At a minimum, the accused business spends a lot of time and money defending bad-sounding documents and ultimately suffers from the public perception they create; at worst, the business may fail in that defense and end up paying millions of dollars in the form of legal settlements, regulatory fines, or awarded damages. Similarly, although the risks of litigation are less, government workers may inadvertently generate documents that could be embarrassing to themselves and the government, and in some cases result in legal liability. In general, the possibility of embarrassment and potential litigation exposure exists whenever a human user generates a document on behalf of his or her employer.

As an example, studies have shown that up to ten percent of employers have been subpoenaed to produce employee e-mails in lawsuits. In a majority of these cases claims of sexual harassment or discrimination were based upon employee e-mail. Of course, the problem is not limited to e-mails. Paper documents of all types and electronic presentations (such as PowerPoint presentations) can form the basis of a lawsuit against an employer.

Usually, people create documents about ideas, plans, and business actions that are unquestionably lawful. In this circumstance, there is a need for assistance in avoiding the use of words and phrases that could suggest otherwise. But there exists a second universe of document creators who want to write about ideas, plans, and actions that they believe to be lawful and proper, but which may not be. In this latter case, the need is for a system designed to alert the document's author, or other people in the business, as to the questionable nature of these ideas and plans, before a document is finalized, communicated, or worst of all, acted upon.

To address some of the problems identified above, businesses have put in place e-mail and document policies designed to reduce the possibility of inadvertent liability. Many businesses regularly monitor e-mails, for example, to check for items that might subject the business to liability, particularly in the sexual harassment and discrimination areas. In addition, some businesses provide written guidance to employees as to what is and what is not acceptable. Training for employees is also made available at some businesses.

Software has been made available to address the problems of profane and racist e-mails. Typically, this software has a list of words which it compares to a completed e-mail before the e-mail is allowed into or out of the protected system. At least some of these software products provide an administrator discretion whether or not to block an offending e-mail, and to adjust the list of prohibited words. Such software solutions fail to address legal problems that can arise outside the area of sexual and racial discrimination claims. Moreover, they are relatively inflexible and require the business to make all decisions as to what is and what is not appropriate. For example, words and phrases that would be inappropriate for documents generated by a sales and marketing department might be quite acceptable in documents authored by the law department addressing legal issues. In addition, currently available software products typically are applied only to completed e-mails. It would be vastly preferable to have a system that addressed legal issues before the e-mail or other document was completed, and to have such a system that was broadly applicable to all documents—not just e-mails.

### SUMMARY OF THE INVENTION

Among the various objects and features of the present invention are the provision of an improved system for helping avoid the creation of “bad” documents.

Another object is the provision of such a system that examines both individual words and groups of words.

A third object is the provision of such a system that is applicable to documents of all types, including e-mails, electronic presentations, and word processing documents.

A fourth object is the provision of such a system that provides assistance in avoiding the use of inappropriate words and groups of words.

A fifth object is the provision of such a system that identifies legally questionable words and groups of words before a document is finalized.

A sixth object is the provision of such a system that is broadly applicable or adaptable to various legal areas and is not limited to identifying words associated with sexual or racial discrimination claims.

A seventh object is the provision of such a system that is flexible in use and application.

An eighth object is the provision of such a system that is easy to use.

A ninth object is the provision of such a system that can provide different levels of monitoring as a function of the authority level of the user or business entity creating the document.

A tenth object is the provision of such a system that provides for routing offending documents to an appropriate reviewer, depending upon the identity of the user creating the document.

An eleventh object is the provision of such a system that provides detailed reports reflecting the identity of users creating offending documents, an identification of the offending words or groups of words in the offending documents, and the like, as desired by a system administrator.

Different embodiments of the invention may involve one or more of the objects and features mentioned above. Further features and advantages of the present invention, as well as the structure and operation of various embodiments of the present invention, are described in detail below with reference to the accompanying drawings.

Briefly, in a first embodiment, a document review system of the present invention includes at least one electronically implemented dictionary containing preselected words and groups of words, the words and groups of words being preselected as potentially unsuitable in communications by and on behalf of an organization. An electronic record of preselected usage levels of authority for the organization is stored, the record containing at least two different usage levels. At least some of the preselected words and groups of words have associated therewith at least one usage level. A processor has access to a communication in electronic form as the communication is being prepared by at least one human user. The processor operates in accordance with programming to identify input words and groups of words inputted by the human user, and compares the input words and groups of words with the preselected words and groups of words to identify matches. The communication being prepared by the human user has associated therewith identification information relating to the human user preparing the document. The processor is responsive to the usage levels of authority for the matched word or group of words and to the identification information for the human user to send a message that a match has been identified when the usage level for the matching word or group of words exceeds an authority level corresponding to the identification information relating to the human user.

In a second aspect of the present invention, a document review program includes at least one electronically implemented dictionary containing preselected words and groups of words, the words and groups of words being preselected as potentially unsuitable in communications by and on behalf of an organization, an electronic record of preselected usage levels of authority for the organization, the record containing at least two different usage levels, at least some of the preselected words and groups of words having associated therewith at least one usage level, and a computer program for execution on a computer processor. The processor has access to a communication in electronic form as the communication is being prepared by at least one human user, and the computer program controls the processor to identify input words and groups of words inputted by the human user, and to compare the input words and groups of words with the preselected words and groups of words to identify matches. The communication has associated therewith identification information relating to the human user preparing the document. The computer program further controls the processor to respond to the usage level for the matching word or group of words and to the identification information for the human user to send a message that a match has been identified when the usage level for the matching word or group of words exceeds an authority level corresponding to the identification information relating to the human user.

In a third aspect of the present invention, a method of reviewing documents for suitability includes the steps of storing preselected words and groups of words in electronic form, the words and groups of words being preselected as potentially unsuitable in communications by and on behalf of an organization, setting and storing preselected usage levels of authority for the organization, at least some of the preselected words and groups of words having associated therewith at least one usage level, accessing a communication in electronic form as the communication is being prepared by at least one human user, the communication having associated therewith identification information relating to the human user preparing the document, identifying input words and groups of words inputted by the human user, comparing the input words and groups of words with the preselected words and groups of words to identify matches, and sending a message in response to the usage level for the matching word or group of words and to the identification information for the human user, the message indicating that a match has been identified when the usage level for the matching word or group of words corresponds to the identification information relating to the human user.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a block diagram illustrating the major components of the system of the present invention; and

FIG. 2 is a flow chart illustrating the operation of the system of the present invention.

### DETAILED DESCRIPTION OF THE PREFERRED EMBODIMENTS

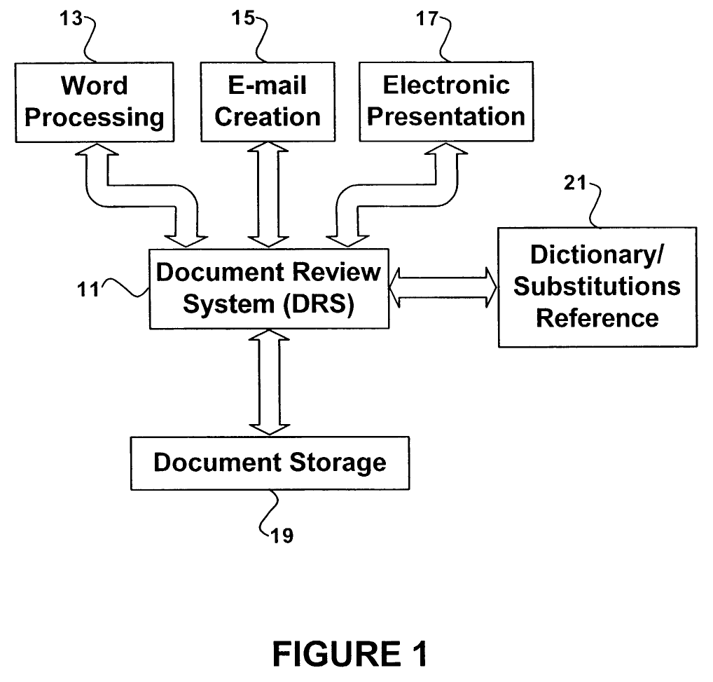

Referring to the accompanying drawings in which like reference numbers indicate like elements, FIG. 1 illustrates a document review system (DRS) 11 of the present invention. DRS 11 as shown in FIG. 1 is configured as an interface between various document applications such as a word processing application 13, an e-mail application 15, and an electronic presentation application 17 on the one hand, and document storage 19 on the other. For example, word processing application 13 could be the program sold under the trade designation Word by Microsoft, e-mail application 15 could be the e-mail component of the program sold under the trade designation Microsoft Outlook by Microsoft, and electronic presentation application 17 could be the program sold under the trade designation PowerPoint by Microsoft. Of course, the present invention is not limited to use with these particular application programs. Application programs from any company and of varying degrees of complexity fall within the scope of usability in the present invention. Moreover, the invention is usable with any one application, if desired. Moreover, although the present description shows the DRS as external to the applications 13, 15 and 17, the functions of the DRS could be incorporated into the applications themselves without falling outside the scope of the present invention. Similarly, the particular relationship of the document storage 19 and DRS 11 shown in FIG. 1 is not critical to the present invention. Document storage may, if desired, be controlled directly by applications 13, 15, or 17 instead of by DRS 11.

As is well known, one way to access to applications 13, 15, and/or 17 is through the use of an application program interface (API). For example, such an interface used in connection with the handling of documents is shown in U.S. Pat. No. 6,324,551, the disclosure of which is incorporated herein by reference. In that patent, the documents themselves are treated as Java objects. Although the '551 patent describes one way of constructing such an interface, the present invention is not limited to any such method. Many different programming techniques are capable of performing the desired functions for the DRS 11, and all fall within the intended scope of the present invention.

DRS 11 is preferably implemented as including a software program running on a computer processor. The processor may or may not be the same as the processor running one or more of the applications 13, 15, and 17. For example, in networked situations, DRS 11 can run on a server in the network to interact with networked programs like e-mail and could also run as a client application running on a desktop personal computer. DRS 11 has access to a data store 21 containing various dictionaries and related information, as described in more detail below. In the context of the hardware involved, this means that the software program causes the processor at the appropriate times (again, as described below) to access data store 21 to retrieve data used by the program.

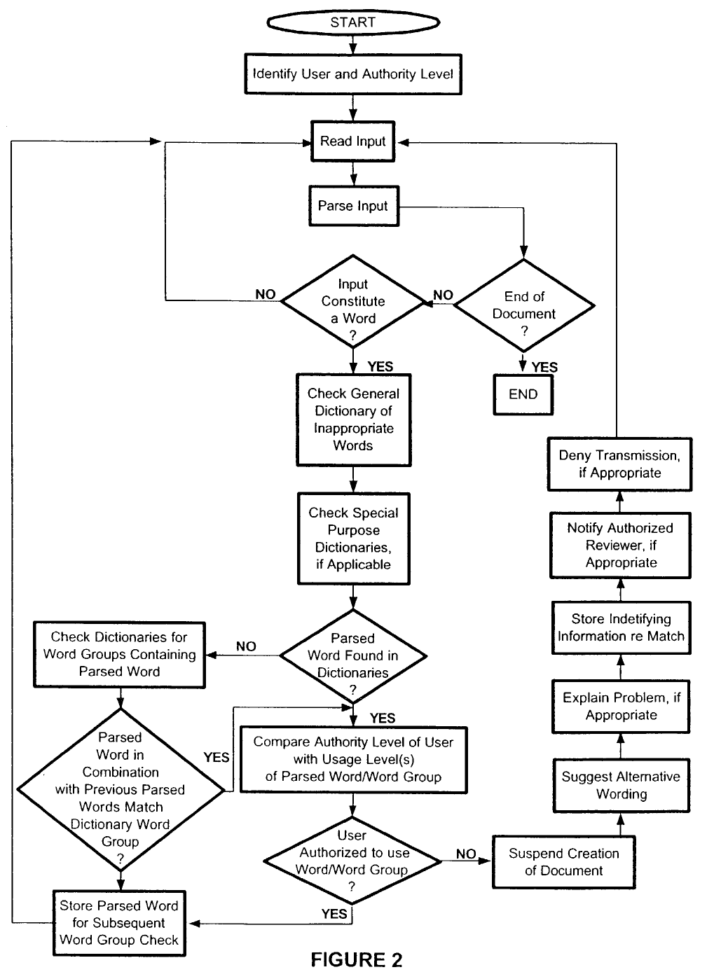

More specifically, DRS 11 uses the software program to edit documents (and assist in the editing of documents) while they are being created. As shown in FIG. 2, the program first identifies the user. This can involve either an identification of the particular person, or the identification of a particular class of users. The former, for example, identifies the user as the person associated with the particular computer being used to provide the input. To provide class identification information, the DRS 11 must be provided with grouping information that associates each computer being monitored with a particular class. An example of class identification might be “human resources department”. An example of individual user might be “John Jones”.

Each user has associated therewith an authority usage level, either by virtue of his or her actual identity or by virtue of the class in which he or she falls. Different users may have different authority levels. An excerpt of an authority level record follows:

| Name | Authority Level |
|---|---|
| . | . |
| . | . |
| . | . |
| Jones, John | A2 |
| Klaban, Mitch | HR1 |
| Lavin, Joan | MS3 |
| Law | L1 |
| Marketing & Sales | MS1 |
| Operations | O1 |
| Seiler, Tom | L4 |
| . | . |
| . | . |
| . | . |

In this hypothetical record, John Jones has an authority level of A2. The “A” indicates that Mr. Jones is in the accounting department, and the “2” indicates that he has the second level of authority from the bottom for that department. Similarly, Mitch Klaban has the lowest level of authority in the human resources department, Joan Lavin has the third level of authority in the marketing and sales department, and Tom Seiler has the fourth level of authority in the law department. The hypothetical record above also shows that the default level of authority in the law department is L1, the default in marketing and sales is MS1, and the default level in operations is O1. The use to which these authority levels are put is explained below.

After identifying the user, the system 11 reads the input as the document is being created (see FIG. 2). (Alternatively, the document may be reviewed by system 11 once it is completed but before the document is closed, printed or sent.) It is necessary to parse the input to determine when a completed word has been inputted. It is contemplated that input may be either by means of a keyboard or similar input device, or by means of a microphone. In either case, the rules for parsing the input to identify words are well-known. For example, in most English text inputted by keyboard words are separated by spaces or form of punctuation (period, comma, semi-colon, colon, slash, dash, etc., but usually not a hyphen). If the input is aural, a conventional speech recognition program may be used to identify words in the aural stream.

If the input is a word, system 11 first screens the word against a general dictionary, specifically a dictionary that contains words and groups of words that are deemed generally inappropriate for business writing. The general dictionary includes things like profanity, racially oriented, and sexually oriented language. In addition, certain businesses might desire to incorporate military jargon and terminology in the general (or universal) dictionary. Terms in the general dictionary have associated therewith a usage level of “5”, indicating that only a person with an authority level of “5” or higher may use the words and groups of words therein. Of course, a business may conclude that no one in the business may use terms contained in the general dictionary in documents prepared on company equipment. Usually, however, at least one person in human resources or the law department will need to have an authority level high enough to use these terms for the purpose of preparing documents warning against their use.

In addition to checking the general, or universal dictionaries, system 11 also checks various specialized or special purpose dictionaries for a match against the word or group of words inputted. The special purpose dictionaries are modular in nature and incorporate subjects of importance to a particular business. It is contemplated that the special purpose dictionaries are tailored to particular parts of the law or areas of a business where special care should be taken in preparing documents. For example, the special dictionaries will include:

1. Competition Dictionary—words, phrases, and strings of words or phrases that can be problematic when used in the context of competition, competitors in general, or specific competitors by name (client specific).

2. Litigation Dictionary—words, phrases, and strings of words or phrases that suggest the author is writing about or referring to pending or potential litigation.

3. Pricing Dictionary—language that could be misinterpreted as it relates or planned or proposed pricing actions.

4. Title 7 Human Resources Dictionary—words and phrases that can be inappropriate when used in discussing personnel issues, problems and activities.

5. Product Performance Dictionary—language that can be problematic when used in describing the intended purpose, performance, or effectiveness of a particular product.

6. Intellectual Property and Trade Secrets Dictionary—words, phrases, strings of words or phrases, project names, etc. that should not be used in preparing documents.

7. Hazardous Material—words and phrases that can be inappropriate when used in discussing hazardous material issues, problems and activities.

The special purpose dictionaries are preferably scored and validated by different practicing attorneys with experience in commercial litigation and by experienced in-house counsel.

An example of a special purpose pricing dictionary follows:

### Competition Dictionary

Alone* or in relation to: competitors, competition, competitors by name (client/sector specific), market opponents, etc.

| | |
|---|---|
| 1. Ambush | A3, HR2, L1, MS3, O3 |
| 2. Annihilate | A1, HR4, L1, MS3, O2 |
| 3. Attack (?) | A2, HR4, L2, MS4, O1 |
| 4. Blast | A1, HR1, L1, MS2, O1 |
| 5. Block | A1, HR1, L1, MS1, O1 |
| 6. Bomb | A3, HR2, L1, MS3, O3 |
| 7. Bombard | A1, HR4, L1, MS3, O2 |
| 8. Boycott | A2, HR4, L2, MS4, O1 |
| 9. Butcher | A1, HR4, L1, MS3, O2 |
| 10. Cartel | A2, HR4, L2, MS4, O1 |
| 11. Castrate | A1, HR4, L1, MS3, O2 |
| 12. Crush | A1, HR4, L1, MS3, O2 |
| 13. Debilitate | A2, HR4, L2, MS4, O1 |
| 14. Decimate | A1, HR4, L1, MS3, O2 |
| 15. Demolish | A1, HR4, L1, MS3, O2 |
| 16. Destroy | A1, HR4, L1, MS3, O2 |
| 17. Devastate | A1, HR4, L1, MS3, O2 |
| 18. Dismember | A1, HR4, L1, MS3, O2 |
| 19. Dominate | A1, HR2, L1, MS2, O1 |
| 20. Eliminate | A1, HR2, L1, MS2, O1 |
| 21. Eradicate | A1, HR4, L1, MS3, O2 |
| 22. Exterminate | A1, HR4, L1, MS3, O2 |
| 23. Force | A2, HR4, L2, MS4, O1 |
| 24. Hostage | A2, HR4, L2, MS4, O1 |
| 25. Impair | A2, HR4, L2, MS4, O1 |
| 26. Impede | A2, HR4, L2, MS4, O1 |
| 27. Kill* | (A3, HR5, L2, MS5, O3) |
| | A1, HR4, L1, MS3, O2 |
| 28. Market /division, /divide, / | A2, HR2, L2, MS5, O3 |
| apportion, /allocation | |
| 29. Monopoly, monopolize | A2, HR2, L2, MS5, O3 |
| 30. Murder* | (A3, HR5, L2, MS5, O3) |
| | A1, HR4, L1, MS3, O2 |
| 31. Mutilate | A1, HR4, L1, MS3, O2 |
| 32. Maim | A1, HR1, L1, MS3, O2 |
| 33. Neutralize | A2, HR4, L2, MS4, O1 |
| 34. Nuke | A1, HR4, L1, MS3, O2 |
| 35. Nullify | A2, HR4, L2, M54, O1 |
| 36. Obliterate | A1, HR4, L1, MS3, O2 |
| 37. Plunder | A1, HR4, L1, MS3, O2 |
| 38. Pillage | A1, HR4, L1, MS3, O2 |
| 39. Predator | A2, HR3, L2, MS3, O1 |
| 40. Quash | A1, HR4, L1, MS3, O2 |
| 41. Quell | A2, HR4, L2, MS4, O1 |
| 42. Raid | A1, HR4, L1, MS3, O2 |
| 43. Ransack | A1, HR4, L1, MS3, O2 |
| 44. Ravish | A1, HR4, L1, MS3, O2 |
| 45. Ravage | A1, HR4, L1, MS3, O2 |
| 46. Reduce | A1, HR2, L1, MS1, O1 |
| 47. Ruin | A1, HR4, L1, MS3, O2 |
| 48. Sabotage | A1, HR4, L1, MS3, O2 |
| 49. Shatter | A1, HR4, L1, MS3, O2 |
| 50. Squelch | A1, HR4, L1, MS3, O2 |
| 51. Smash | A1, HR4, L1, MS3, O2 |
| 52. Stomp | A1, HR4, L1, MS3, O2 |
| 53. Strike | A1, HR3, L2, MS2, O3 |
| 54. Torture | A1, HR4, L1, MS3, O2 |
| 55. Trample | A1, HR4, L1, MS3, O2 |
| 56. Trash | A1, HR4, L1, MS3, O2 |
| 57. Vaporize | A1, HR4, L1, MS3, O2 |
| 58. Vanquish | A1, HR4, L1, MS3, O2 |
| 59. Wipe out | A1, HR4, L1, MS3, O2 |
| 60. Wreck | A1, HR4, L1, MS3, O2 |

In this example of a special purpose dictionary, usage levels are indicated for each department in the business. For example, in accounting anyone with an authority level of A1 or above could use the word “wreck”, while in human resources only persons with authority level HR4 or above could use the same word. In the law department, anyone with at least authority level L1 could use the word “wreck”, in marketing and sales a level of MS3 or higher would be required, and in operations an authority level of O2 or higher would be required. Of course, in the simplest case, the competition dictionary would apply only to the marketing and sales department (the other departments would have their own special purpose dictionaries), and all the usage levels would be the same. The system of the present invention is flexible enough to allow that simplest case to be implemented while not precluding the use of the more complex system illustrated above. Of course, not all special purpose dictionaries need be applied to all users or all departments of the business.

Note in the illustration above as well that the words “kill” and “murder” are rated as to usage level both when used alone and when used in connection with competitors, competition, competitors by name (client/sector specific), market opponents, and the like. In the later case, the set of usage levels in parentheses is used since the risk is heightened. Note as well that the example includes the group of words Market /division, /divide, /apportion, /allocation. In this entry the “/” indicates that a match occurs when the word “market” appears with any of the words following a slash. So if the document uses the words “market” and “allocation” within a predetermined distance of each other (e.g., within the same sentence, or within the same paragraph), system 11 would declare a match.

For purposes of illustration, a typical pricing special purpose dictionary (without the usage levels) is shown below.

### Pricing Dictionary

Alone* or in relation to: planned, proposed, or considered pricing

1. Standardization

2. Fix, fixing

3. Leverage

4. Bundling

5. Tie, tying

6. Below cost

7. Below average, short-run, long-run, distributed, etc., cost

8. Gouge, gouging

9. Sharing

10. Cartel

11. Consortium

12. Cooperative

13. Signal(s), signaling

14. Mimic

15. Floor

16. Cap

17. Barriers

18. Leader

19. Loss leader

20. Unbelievable

21. Incredible

22. Defensible

23. Indefensible

24. Rock bottom

25. Bargain basement

26. Unbeatable

27. Untouchable

28. Cut throat

29. Homicidal

30. Suicidal

31. Blistering

The special purpose dictionaries for different areas are similarly constructed. For example, in the intellectual property special purpose dictionary words like “obvious”, “copy/competitor”, “steal”, “misappropriate”, “actual confusion”, and similar words would be listed with various usage levels depending upon the identity of the document creator.

Returning to FIG. 2, system 11 (after checking the general and special purpose dictionaries) determines if there is a match for the word. If there is not, it then checks for a word group match. If there is no word or word group match, the word is stored for subsequent word group match testing, and the system returns to reading the input, and repeats the process. If there is a word or a word group match, system 11 checks the authority level of the user against the usage level of the parsed word or word group. If the user has an authority level sufficient to use the parsed word or word group, the word is simply stored for future word group checks. On the other hand, if the authority level of the user is not high enough to use the word or word group in question, system 11 temporarily suspends creation of the document. At that point, system 11 may, if desired, take several actions. For one, it preferably issues the author appropriate cautions along with pertinent definitions and suggested alternative wording. This allows the user to quickly identify the problem and probably solve it. For example, if the offending word is “kill”, system 11 has stored the following possible alternatives—“vigorously compete with”, “reduce the adverse effects of”, etc. that it displays to the user. In addition, the display would include an explanation of why the word “kill” is inappropriate in business communications. It should be understood that system 11 does not simply use a conventional thesaurus to suggest alternative wording. In the case of “kill” for example, a conventional thesaurus simply provides words like “annihilate”, “exterminate”, and “slaughter”, each of which is just as problematic as the offending term. Rather, the alternative suggestions are analyzed, before display to the user, for their legal effect.

In addition to addressing a communication to the user to attempt to solve the problem, system 11 also records identifying information concerning the match in a table for future use. For example, a typical match table would look like the following:

| | Offending | | | |
|---|---|---|---|---|
| Incident No. | Word/Group | User ID | Date/Time | Action |
| 0004 | “kill” | 007 | 020402/0914 | Word changed |
| 0005 | “monopolize” | 001 | 020402/0915 | Reported to legal |
| 0006 | “barriers” | 107 | 020402/0918 | E-mail blocked |

. . .

Additional fields could be added to the match table as desired to record the information desired by a particular business.

In a network application like email, system 11 is preferably used to deny the transmission of an inadequately edited email or to direct that email to higher management for review and intervention. Similarly, when matches occur in other types of documents the system preferably notifies an authorized reviewer (either immediately, or at regular intervals). For example, in the case of a human resources user using a word that is one level above her authorization level, the authorized reviewer could be her immediate supervisor in human resources. Use of a word requiring a higher level of authority may require that the document be reviewed by someone in the law department. It should be understood that numerous rules can be set concerning who is an authorized reviewer in any particular circumstance. Thus, system 11 incorporates a hierarchy of sorts so that, depending on the severity of the potential problem, the document can be suspended, quarantined, or reported to others in the business, for example the legal staff, for review and intervention.

It should be understood that system 11 affords different business entities (departments, groups, divisions, etc.) within a business and different individuals within those entities different levels of authority in the creation of documents with varying levels of system intervention. One person who writes about a competitive strategy and uses the phrase “barriers to entry” may receive a brief tutorial and wording suggestion, while another writer who uses the same phrase may be referred to the legal staff for guidance.

After taking the necessary actions, system 11 returns to reading the input to repeat the process for the next word.

At desired intervals, or upon request, system 11 generates detailed reports on an individual or business entity level, relating to interaction with the system and pertinent results including number of alerts by type, writer response to alerts by type, suspended documents, quarantined documents, legal staff or managerial referrals, and the like. Preferably the match tables are stored in database form to facilitate the generation of such reports. As is well-known, both standard and customized reports may be generated from a properly structured and populated database.

It should be appreciated that system 11 is particularly useful not only to larger businesses with in-house legal staffs that can serve as the authorized reviewer, but also to smaller businesses that have no in-house legal capability. In the latter case, system 11 alerts the business to potential legal problems that it might otherwise have ignored to its detriment. The system is also particularly useful to larger businesses with strong or dominant market positions, since the risk resulting from inappropriate documents is increased for those businesses. Similarly, businesses that are heavily regulated, those that produce or market high-risk, health-effecting products, and those operating in geographic areas known for litigiousness would especially benefit from system 11. Other potential users who could benefit greatly from system 11 are businesses without formal document-preparation training programs, or document retention and disposal policies; businesses with high turnover of employees most likely to create documents; and businesses that have been historically burdened with litigation.

Although system 11 has been described as setting apart from popular word processing applications like Word and Word Perfect, with presentation software like Power Point, and with email programs, it should be understood that the functions of system 11 may also be programmed directly into such applications.

As various modifications could be made in the systems and methods herein described and illustrated without departing from the scope of the invention, it is intended that all matter contained in the foregoing description or shown in the accompanying drawings shall be interpreted as illustrative rather than limiting.

What is claimed is:

1. A document review system comprising:
at least one electronically implemented dictionary containing preselected words and groups of words, said words and groups of words being preselected as potentially unsuitable in communications by and on behalf of an organization;
an electronic record of preselected usage levels of authority for the organization, said record containing at least two different usage levels, at least some of the preselected words and groups of words having associated therewith at least one usage level;
a processor having access to a communication in electronic form as said communication is being prepared by at least one human user, said processor operating in accordance with programming to identify input words and groups of words inputted by said human user, and to compare said input words and groups of words with the preselected words and groups of words to identify matches;
said communication having associated therewith identification information relating to the human user preparing the document;
said processor being responsive to the usage levels of authority for the matched word or group of words and to the identification information for the human user to send a message that a match has been identified when the usage level for the matching word or group of words exceeds an authority level corresponding to the identification information relating to the human user.

2. The document review system as set forth in claim 1 wherein the message communicates to the user that a match has been identified.

3. The document review system as set forth in claim 1 wherein the message is sent to an authorized reviewer of the user's communication, and informs said reviewer that a match has been identified.

4. The document review system as set forth in claim 3 wherein the message identifies the match to the authorized reviewer.

5. The document review system as set forth in claim 1 wherein the message is sent to the user, said message including a definition of the word or group of words that was the subject of the match.

6. The document review system as set forth in claim 1 wherein the message includes at least one alternative word or group of words to substitute for the match.

7. The document review system as set forth in claim 1 wherein the processor blocks transmission of the communication containing the match.

8. The document review system as set forth in claim 1 wherein the message communicates a preselected caution to the user.

9. The document review system as set forth in claim 1 wherein the organization has at least two sub-entities, the electronic record having different usage levels for the two sub-entities for at least some of the preselected words and groups of words.

10. The document review system as set forth in claim 1 wherein at least some users have different usage levels stored in the electronic record for at least some of the preselected words and groups of words.

11. The document review system as set forth in claim 1 wherein the communication is prepared using a word processing program.

12. The document review system as set forth in claim 1 wherein the communication is prepared using an e-mail program.

13. The document review system as set forth in claim 1 wherein the communication is prepared using a slide presentation program.

14. The document review system as set forth in claim 1 wherein said preselected unsuitable words and groups of words include a first set of words and groups of words that are inappropriate for general usage, and a second set of words and groups of words that are inappropriate in specific contexts.

15. The document review system as set forth in claim 14 wherein the second set of words and groups of words is specific to communications relating to competition.

16. The document review system as set forth in claim 14 wherein the second set of words and groups of words is specific to communications relating to litigation.

17. The document review system as set forth in claim 14 wherein the second set of words and groups of words is specific to communications relating to pricing.

18. The document review system as set forth in claim 14 wherein the second set of words and groups of words is specific to communications relating to human resources.

19. The document review system as set forth in claim 14 wherein the second set of words and groups of words is specific to communications relating to product performance.

20. The document review system as set forth in claim 14 wherein the second set of words and groups of words is specific to communications relating to intellectual property.

21. The document review system as set forth in claim 14 wherein the preselected unsuitable words and groups of words further includes a third set of words and groups of words relating to military terms.

22. The document review system as set forth in claim 14 wherein the preselected unsuitable words and groups of words further includes a third set of words and groups of words relating to technical jargon.

23. The document review system as set forth in claim 14 wherein words and groups of words of the second set are prescored and validated by professionals.

24. The document review system as set forth in claim 1 wherein information concerning matches are stored in electronic form.

25. The document review system as set forth in claim 24 further including reports compiled from the stored information concerning matches, said matches being grouped into a plurality of types.

26. The document review system as set forth in claim 25 wherein at least one report relates to matches for an individual user.

27. The document review system as set forth in claim 25 wherein at least one report relates to matches for a sub-entity of the organization.

28. The document review system as set forth in claim 25 wherein at least one report relates to total number of matches.

29. The document review system as set forth in claim 28 wherein said report includes a breakdown of the total number of matches by type.

30. The document review system as set forth in claim 25 wherein at least one report relates to user response to matches.

31. The document review system as set forth in claim 30 wherein said report includes a breakdown of user response by type of match.

32. The document review system as set forth in claim 25 wherein said report includes a record of suspended documents.

33. The document review system as set forth in claim 25 wherein said report includes a record of quarantined documents.

34. The document review system as set forth in claim 25 wherein said report includes a record of document referrals.

35. The system as set forth in claim 1 wherein the processor identifies input words and groups of words inputted by said human user as said input words and groups of words are added to the communication.

36. The system as set forth in claim 1 wherein the identification information is personal to the human user.

37. The system as set forth in claim 1 wherein the identification information relates to a sub-entity containing the human user.

38. A document review program comprising:
at least one electronically implemented dictionary containing preselected words and groups of words, said words and groups of words being preselected as potentially unsuitable in communications by and on behalf of an organization;
an electronic record of preselected usage levels of authority for the organization, said record containing at least two different usage levels, at least some of the preselected words and groups of words having associated therewith at least one usage level;
a computer program for execution on a computer processor, said processor having access to a communication in electronic form as said communication is being prepared by at least one human user, said computer program controlling the processor to identify input words and groups of words inputted by said human user, and to compare said input words and groups of words with the preselected words and groups of words to identify matches;
said communication having associated therewith identification information relating to the human user preparing the document;
said computer program further controlling the processor to respond to the usage level for the matching word or group of words and to the identification information for the human user to send a message that a match has been identified when the usage level for the matching word or group of words exceeds an authority level corresponding to the identification information relating to the human user.

39. A method of reviewing documents for suitability comprising:
storing preselected words and groups of words in electronic form, said words and groups of words being preselected as potentially unsuitable in communications by and on behalf of an organization;
setting and storing preselected usage levels of authority for the organization, at least some of the preselected words and groups of words having associated therewith at least one usage level;
accessing a communication in electronic form as said communication is being prepared by at least one human user, said communication having associated therewith identification information relating to the human user preparing the document;
identifying input words and groups of words inputted by said human user;
comparing said input words and groups of words with the preselected words and groups of words to identify matches;
sending a message in response to the usage level for the matching word or group of words and to the identification information for the human user, said message indicating that a match has been identified when the usage level for the matching word or group of words exceeds an authority level that corresponds to the identification information relating to the human user.
